(19) United States
(12) Patent Application Publication
(10) Pub. No.: US 2009/0081618 A1
(43) Pub. Date: Mar. 26, 2009

(54) SYSTEM AND METHOD FOR IMMEDIATE LOADING OF FIXED HYBRID DENTAL PROSTHESES

(76) Inventor: Frank R. LaMar, Fairport, NY (US)

Correspondence Address: BASCH & NICKERSON LLP, 1777 PENFIELD ROAD, PENFIELD, NY, 14526, US

(21) Appl. No.: 12/236,325

(22) Filed: Sep. 23, 2008

Related U.S. Application Data
(60) Provisional application No. 60/974,853, filed on Sep. 25, 2007.

(51) Int. Cl. A61C 5/08; A61C 8/00

(52) U.S. Cl. 433/218; 433/173

(57) ABSTRACT

Disclosed are apparatus and methods to facilitate the immediate loading of a hybrid prosthesis into the mouth of a patient, thereby avoiding the traditional delay of several months for such devices.

This application claims priority from U.S. Provisional Application 60/974,853, filed Sep. 25, 2007 by F. LaMar, for a “SYSTEM AND METHOD FOR IMMEDIATE LOADING OF MANDIBULAR FIXED HYBRID PROSTHESES,” which is hereby incorporated by reference in its entirety.

The system and methods disclosed herein permit the immediate loading (approximately three weeks) of a hybrid prostheses into the mouth of a patient, thereby avoiding the traditional delay of several months for such devices, and streamlining the number of doctor steps needed to complete the treatment.

### BACKGROUND AND SUMMARY

Crowns and bridges have often been the approach to preserving diseased teeth or replacing lost teeth. However, such devices tend to fail due to the genetic predisposition of tooth decay and periodontal disease that natural teeth cause in some high risk patients. As a result patients often experience an endless cycle of dental work, with the risk that each procedure increasingly limits dental function and compromises quality of life.

As a solution to such problems, the hybrid bridge (Hybridge™) has been developed. Such a bridge replaces all of the patient's upper and/or lower teeth. The bridge is generally permanently supported on five or six dental implants and looks, feels and functions like healthy, natural teeth, and also preserves the jaw bone as a result of stimulation of the bone supporting the implants, thereby preventing bone loss and preserving facial appearance.

It is not unknown to utilize threaded implants to support fixed-detachable dentures and other prostheses within a patient's mouth. Moreover, threaded implants have been used to support prostheses at or shortly after the time the implants are placed. For example, P. A. Schnitman et al. (Int-J-Oral-Maxillofacial-Implants. Jul.-Aug. 12, 1997 (4):495-503), D. P. Tarnow et al. (Int-J-Oral-Maxillofacial-Implants. May-Jun. 12, 1997 (3):319-24) and G. Kammeter et al. (J Prosthetic Dent. May 2001; 87(5):473-476) have all described immediate loading of implants. However, immediate loading of hybrid bridges (within 2-3 weeks of surgery), using the techniques disclosed herein for immediate and early loading are believed to be more predictable, easier, and more precise for a number of reasons, including the manner of preparing for (impressions, etc.), time for producing and fitting hybrid bridges, etc. Moreover, these improved techniques and protocols for edentulous mandibles and maxillas are not believed to have been previously considered.

The timely completion of a fixed hybrid bridge is desirable by many patients. Moreover, the hybrid bridge system and methodology, as disclosed in detail herein, provides a fixed restoration that may be preferred by many patients, provides improved masticatory function, provides improved aesthetics with ideal gingival contours, and importantly is cost effective as it only requires about five to six implants and uses a simplified technique. Most patients are candidates depending upon the quantity of bone in the symphysis of the mandible and the premaxilla of the maxilla. Once a patient is evaluated for a fixed hybrid bridge, one of the treatment protocols disclosed below may be completed in a timely manner to assure a successful outcome.

Disclosed in embodiments herein are both a system and methods for the immediate loading of a fixed hybrid prosthesis, comprising: developing a full denture set-up; fabricating a surgical guide; performing single-stage implant surgery to insert a plurality of implants into the patient's mandible;or maxilla, taking an implant level impressions immediately following implant surgery, wherein at least one impression utilizes the surgical guide; producing a master cast that incorporates implant replicas therein; producing a metal try-in; and final metal/wax try-in; simultaneously, processing and finishing a maxillary and mandibular fixed hybrid prosthesis within three weeks of performing implant surgery; and installing the r fixed hybrid prosthesis.

Further disclosed in embodiments herein is a system and method for the immediate loading of a fixed, hybrid dental prosthesis, comprising: developing a denture set-up; fabricating a surgical guide; performing implant surgery to insert a plurality of implants into the patient's jaw bone; taking an implant level impression immediately following implant surgery, wherein at least one impression utilizes the surgical guide; producing a master cast that incorporates implant replicas therein; producing a metal/wax try-in; processing and finishing a fixed hybrid dental prosthesis within three weeks of performing implant surgery; and installing the fixed hybrid dental prosthesis.

Also disclosed herein is an improved implant post, suitable for use in a dental prosthesis, comprising: an elongated cross-section; and an outer surface including at least one generally planar surface, and a region on said outer surface having a surface roughness to enable the temporary bonding of a polymeric adhesive thereto, said implant post being suitable for use in an implant level impression as well as a fixed hybrid prosthesis.

### BRIEF DESCRIPTION OF THE DRAWINGS

FIGS. 1-4 are illustrative examples of treatment sequences employed for the immediate loading of a fixed, hybrid dental prosthesis;

FIGS. 5-7 are representations of an impression state of the treatment sequences in FIGS. 1-4;

FIG. 8 is an illustration of a wax setup being tried in a patient's mouth pursuant to the treatment sequences of FIGS. 1-4;

FIG. 9 is an illustration depicting a lower denture setup;

FIG. 10 is an illustration of a clear duplicate denture used in various forms as described relative to treatment sequences of FIGS. 1-4;

FIG. 11 is an illustration of the clear denture in a patient's mouth;

FIG. 12 is an illustration of drilling for implants being placed in a patient;

FIG. 13 is an illustration of the implants placed in the bone, and FIG. 14 is an illustration of the same implants once the surgery has been completed;

FIG. 15 is an illustration of the installation of temporary posts in preparation for impressions;

FIG. 16 is a pictorial representation of the configuration of FIG. 15, including improved posts;

FIGS. 17A-B are illustrative examples of alternative post designs;

FIG. 18 is an illustration of the connection of implant posts using a curable adhesive material to produce a jig;

FIG. 19 is an illustration of an impression being produced over the arrangement of FIG. 18;

FIG. 20 is an illustration of a bite registration being taken of the patient;

FIGS. 21-22 are illustrations of implant analogs;

FIGS. 23A-C are illustrations of various aspects of a master cast;

FIG. 24 is a master cast with transferred posts for positioning of the tooth set-up;

FIG. 25 illustrates a completed support structure incorporating posts and bar stock to support the prosthesis;

FIG. 26 is an illustration of the manner in which the matrix of the prosthesis is used to provide reference for the support structure of FIG. 25;

FIG. 27 is an illustration of a wax denture setup;

FIGS. 28-29 are illustrations of the wax denture setup being readied for patient try-in;

FIG. 30 is an illustration of patient try-in of the wax setup depicted in FIGS. 28-29;

FIG. 31 is a review of tooth position using the wax setup;

FIG. 32 is an illustration of exemplary setups for bite registration, face bow record, shade and mold selection;

FIGS. 33 and 34A-B are illustrations of surgical guides for a maxillary treatment sequence;

FIG. 35 is an illustration of a jig created from the surgical guide;

FIG. 36 is an illustration of an upper temporary denture;

FIG. 37 is an illustration of preparation for a closed-tray impression process;

FIG. 38 is an illustration of an exemplary closed tray impression and

FIG. 39 the resulting master cast;

FIGS. 40-42 are illustrations of an open tray process, where the posts are joined prior to taking impressions;

FIGS. 43A-E are illustrations of various aspects of the improved posts disclosed herein;

FIGS. 44, 45 and 46A-D are illustrations of various alternative embodiments and configurations of the posts;

FIGS. 47-48 are further illustration of the improved posts in various figure and prosthesis embodiment, respectively;

FIG. 49 is an illustration of a transitional denture on a model;

FIGS. 50A-C are illustrations of an exemplary embodiment of the improved post; and

FIGS. 51A-B are illustrations of the posts of FIGS. 50A-C in accordance with the methods and practices described herein.

The various embodiments described herein are not intended to limit the system/method to those embodiments described. On the contrary, the intent is to cover all alternatives, modifications, and equivalents as may be included within the spirit and scope of disclosure and the appended claims.

### DETAILED DESCRIPTION

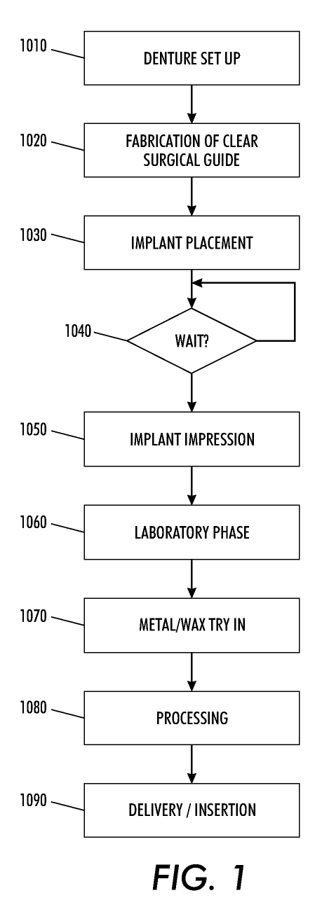

Turning first to FIGS. 1-4, depicted therein are a series of four flowcharts illustrating various treatment sequences that may be employed with the methods and apparatus disclosed herein. The following discussion is related to the various treatment sequences set forth as flowcharts in FIGS. 1-4. With regard to the sequences set forth, it will be appreciated that reasonable modifications and alternatives may be contemplated, and that some operations may be combined or divided, and that some of the operations may be options depending upon the preference of the professional or the nature of the client's situation. Referring to FIG. K, for an edentulous mandibular treatment, the treatment sequence comprises at least the following operations:

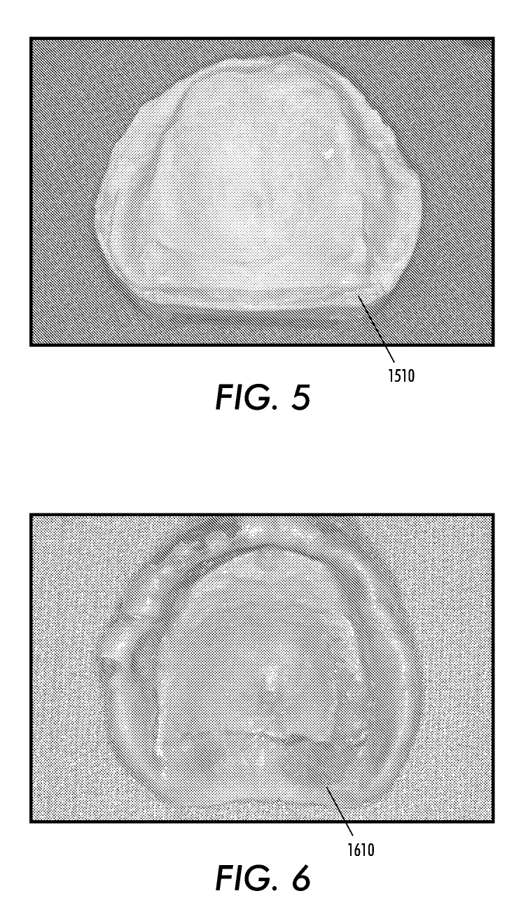

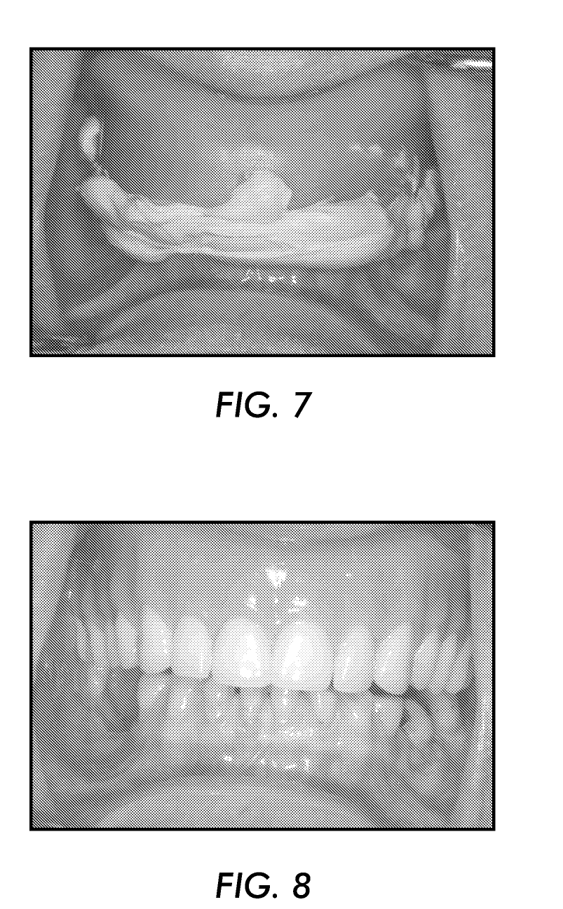

1. DENTURE SET UP APPOINTMENTS (1010): consists of the usual series of appointments (typically five) required to fabricate a complete denture.
a. Obtain primary impression 1510 as illustrated, for example, in FIG. 5.
b. Obtain secondary impression 1610 as depicted in FIG. 6, for example.
c. Prepare a bite registration, face bow record, shade and mold selection, as shown in FIG. 7, for example.
d. An anterior try in may be conducted.
e. A full try of a wax set up as shown at FIG. 8 is then completed.

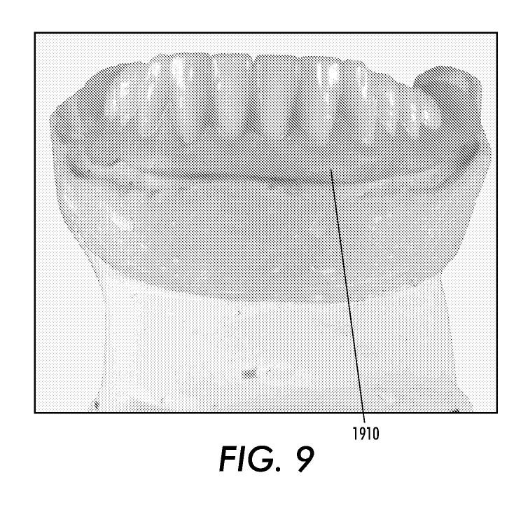

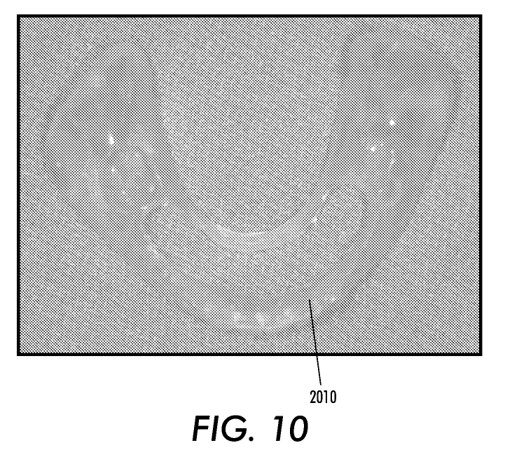

2. FABRICATION OF CLEAR SURGICAL GUIDE (1020): As illustrated, for example in FIGS. 9 and 10, a duplication of the set up of the lower denture 1910 is prepared and then further processed into a clear duplicate denture 2010 by flasking the set-up.

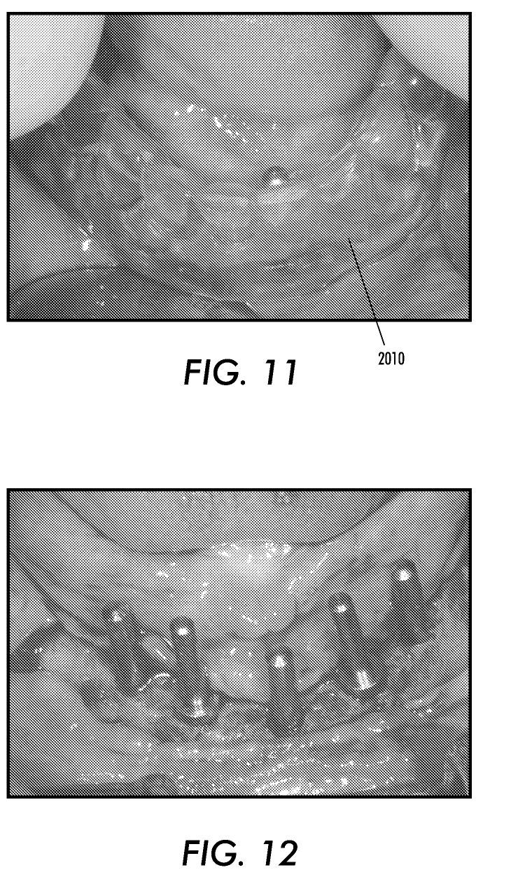

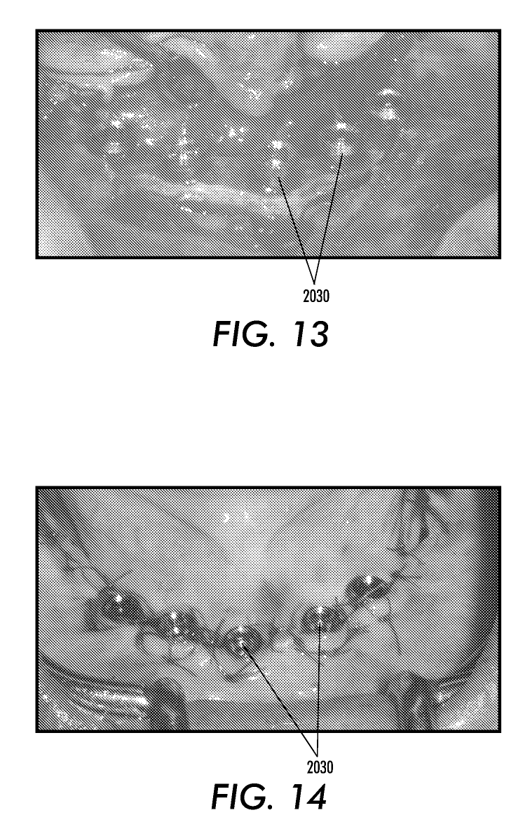

3. IMPLANT PLACEMENT (1030): Surgical placement of the implants using the clear surgical guide 2010 as a way to position the implants in their ideal trajectory. Approximately five to six implants 2030 are evenly spaced between the mental foramen, as depicted for example in the sequence represented by FIGS. 11-14.
0-2 WEEKS: Often the implant impression can be taken the same day as the implants are placed. If there has been a lot of bone reduction, or the soft tissue is loose, the wait time averages approximately two weeks as reflected in 1040.

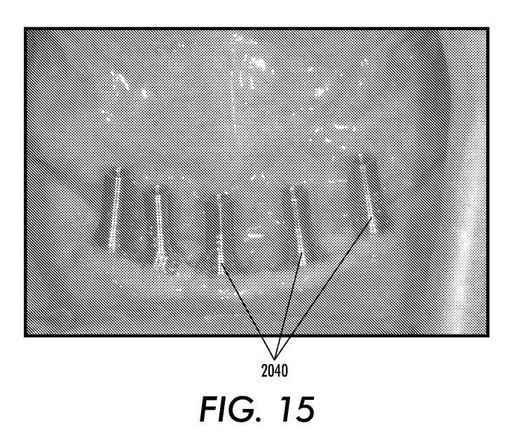

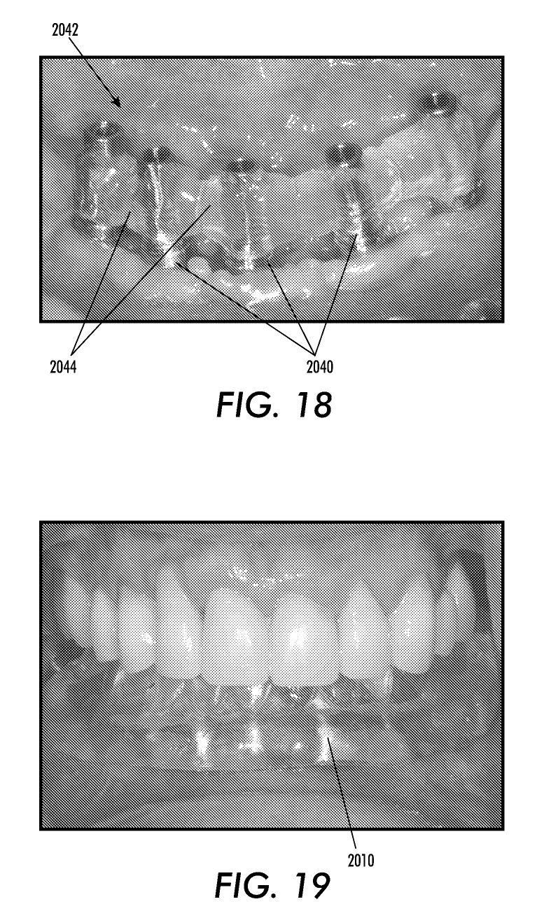

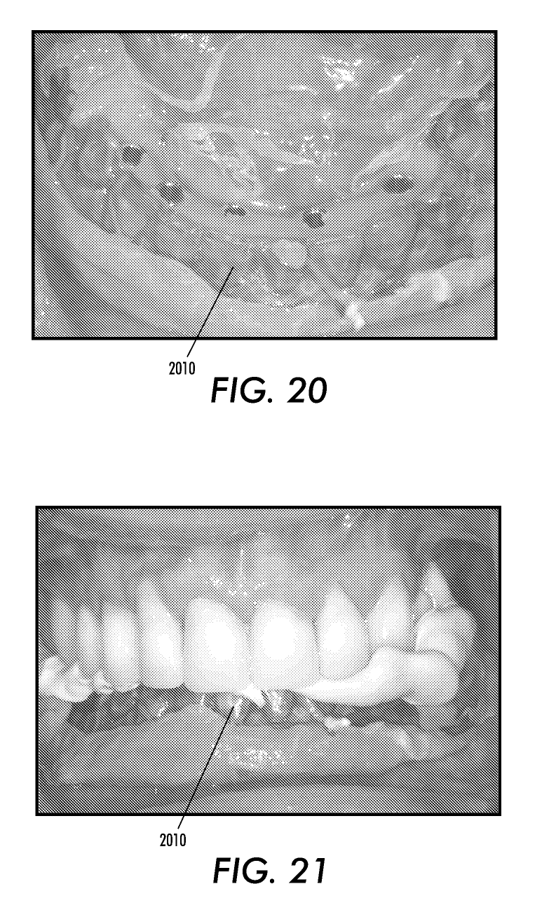

4. IMPLANT IMPRESSION (1050): Referring briefly to FIGS. 15-18, titanium tubes or posts 2040 are used to create a splinted jig 2042 as they are connected by dual cured resin 2044 around and between the posts as depicted in FIG. 18. By connecting the tubes 2040 using a curable resin, the placement accuracy of the impression is much better than a conventional open tray impression. The clear surgical guide 2010 (e.g., FIG. 11) is then filled with impression material, (medium body viscosity), and seated over the splinted jig as illustrated in FIG. 19. A bite registration is taken between the surgical guide 2010 and the opposing teeth as illustrated by FIG. 20. This impression records three aspects in one impression: (i) implant impression, (ii) bite registration and (iii) vertical dimension. This technique is unique to the Hybridge protocol.

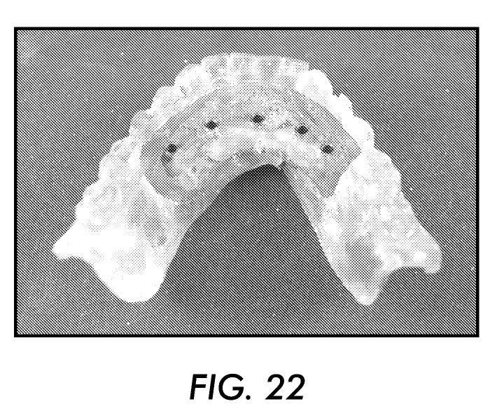

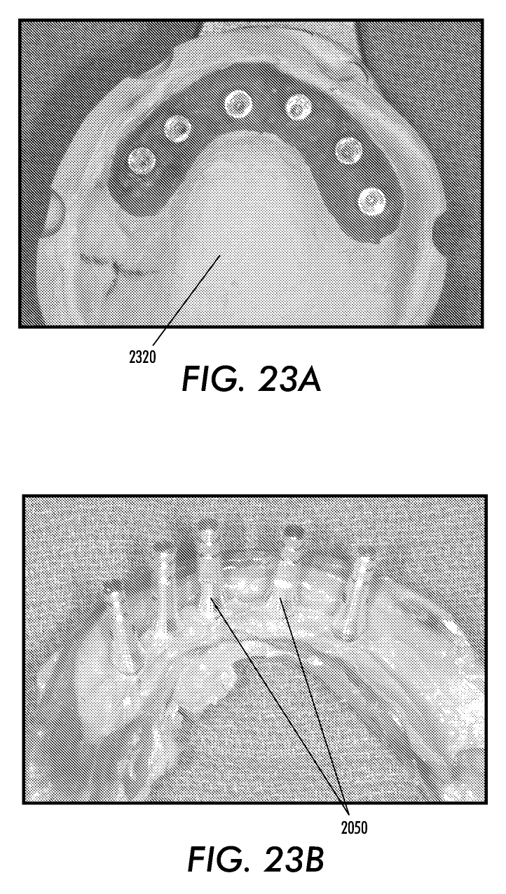

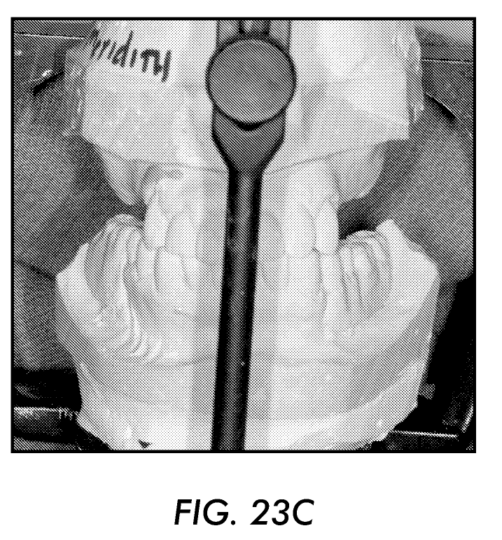

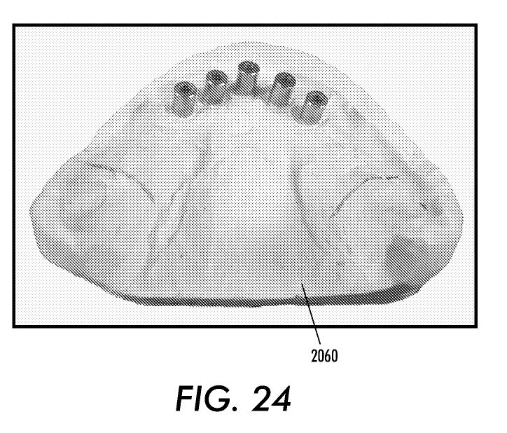

5. LABORATORY PHASE (1060): After implant analogs 2050 are screwed on to the titanium tubes in the impression, for example as depicted in FIGS. 21 and 22. The impression is then poured in stone, creating a Master Cast as illustrated in FIG. 23A, based upon the setup illustrated in FIG. 23B. The cast 2320 is then mounted on an articulator against the opposing upper cast as illustrated, for example, in FIG. 23C. The use of the wax set-up indexed onto the healing caps is helpful to verify the mounting of the cast. An appropriate number of healing caps (one for each implant) are screwed onto the analogs of the master cast. Once placed, the set-up is cut back and seated onto the master cast. The bite registration is then used to mount the cast with the opposing cast. An index is than made of the clear surgical guide/impression tray or wax set-up, using a putty impression material. By indexing the guide or preferably the set-up, the tooth positions from the denture set-up are transferred to the master cast 2060 as illustrated, for example, in FIG. 24.

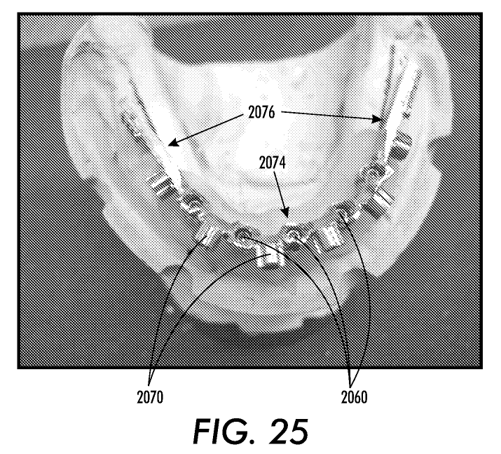

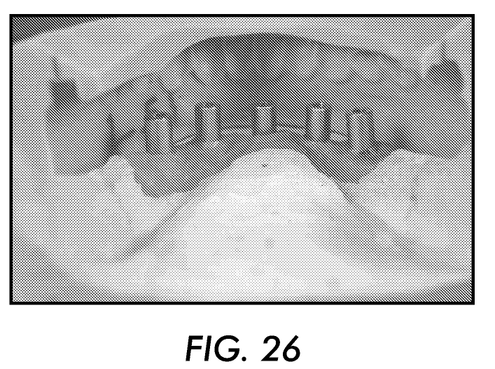

Once the dental technician knows the tooth position relative to the implants (analogs 2050), the titanium framework is fabricated. Referring also to FIG. 25, titanium cylinders or posts 2040 are fastened to the implant analogs, flat sides on posts 2040 are positioned to approximate each other. Titanium bar stock sections 2070, possibly having various features to which a denture may be attached, is than sized to fit between the flat surfaces of the titanium posts and laser welded or otherwise affixed to the posts. The bar 2074 is thereby completely fabricated, including the posterior cantilevers 2076 extending to the molar area. Referring next to FIG. 26, the matrix is referenced to make sure the titanium framework is positioned under the desired location of the denture teeth.

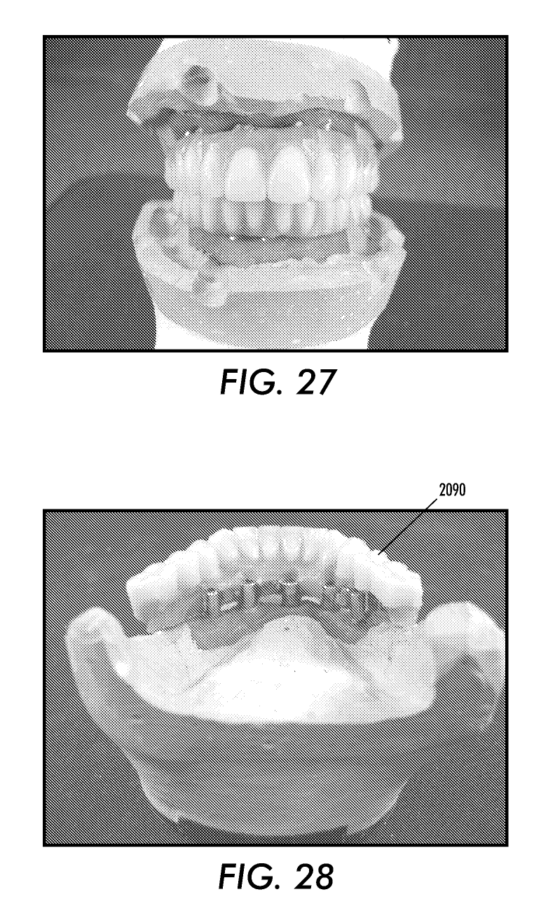

Turning to FIG. 27, once the titanium framework is completed as depicted above, the denture teeth 2080 from the wax denture setup are placed in the matrix, and than waxed on to the titanium bar in their proper location. This then represents the metal/wax try-in 2090 of the Hybridge as seen in FIG. 28.

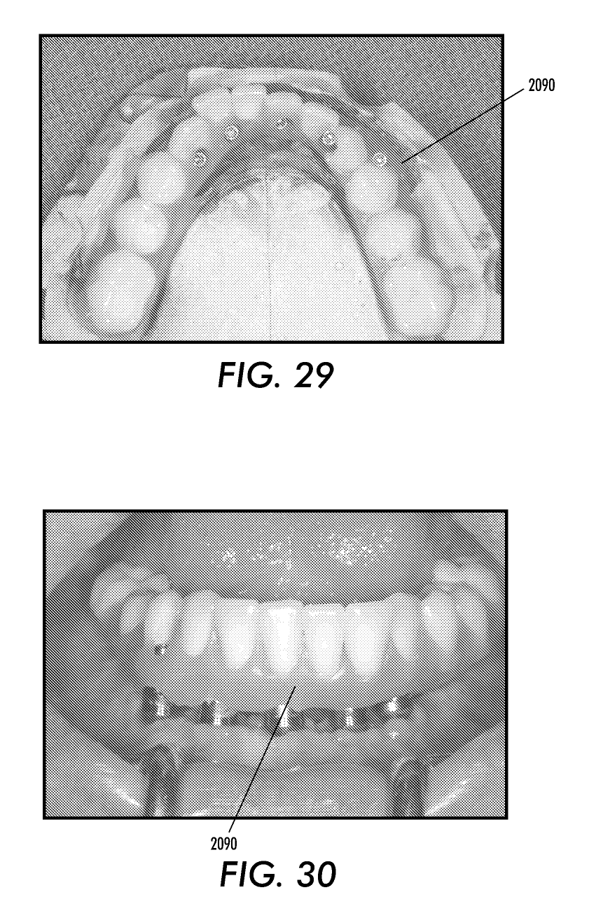

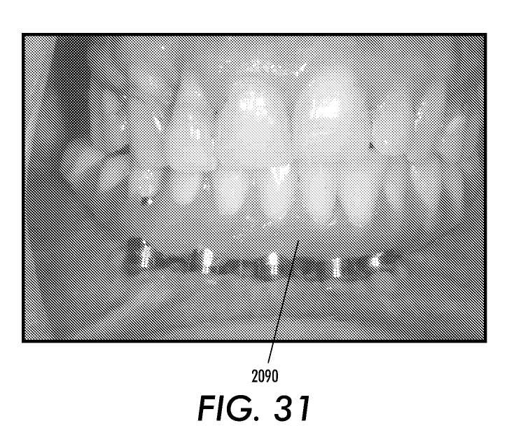

6. METAL/WAX TRY IN (1070): This operation allows verification of the metal/wax try-in 2090 intra-orally. Beginning with FIG. 29, the fit of the framework on to the five implants is verified, carefully checking the passivity of the framework. Once the framework fit is verified, the occlusion (bite) is verified to be accurate as well as illustrated in FIG. 30. Lastly, as represented by FIG. 31, the appearance and tooth position are checked, and the patient has an opportunity to accept the final set-up. If any of the verifications do not check out, new records are taken: check bite to record the occlusal discrepancy, and a solder index to record a passive fitting bar. Unless there are large discrepancies, the final Hybridge can be processed and finished. One of the unique steps of the Hybridge protocol is the use of only a single try-in.

7. PROCESSING (1080): The Metal/Nax Try-In 2090 is flasked and processed with the final acrylic. The Hybridge is fastened back onto the master cast, and the occlusion is checked for a final time and adjusted as necessary.

8. DELIVERY/INSERTION (1090): The Hybridge is screwed onto the implants, the occlusion is checked and adjusted as necessary. The screw access holes are filled with a light-cured resin.

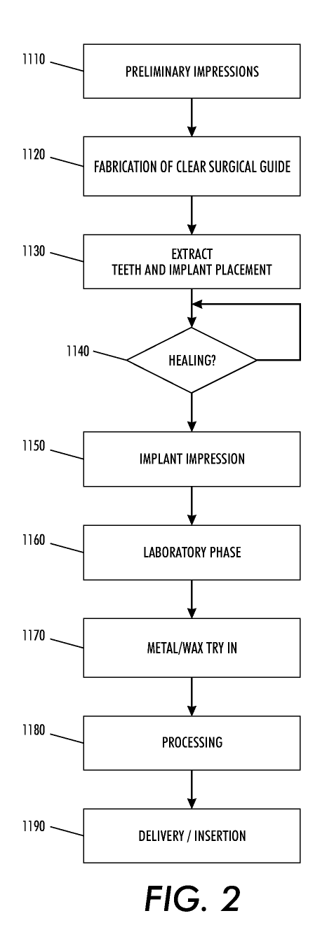

Referring next to FIG. 2, depicted therein are similar operations that are performed for dentate (existing teeth) mandibular treatment. More specifically, the operations are generally indicated as follows:

1 PRELIMINARY IMPRESSIONS (1110): Alginate impressions are taken of the opposing upper dentition and the lower teeth. Bite registration and face bow records are preferred. In one embodiment, three lower impressions are taken, and one upper impression. One of the lower impressions is used to fabricate the lower temporary denture; another is used to fabricate an ideal wax set-up to be used for the final Hybridge. The third impression is kept as a reference if needed in the future. Two shades are selected by the patient, one for the temporary denture, the other for the final set-up.

2. LABORATORY (1120): A lower temporary denture, is fabricated on one of the lower casts, and an ideal wax set-up is made using the second cast. Care is taken to idealize the tooth position, i.e. incisal edge position, and occlusal plane A clear duplicate denture is fabricated of the ideal set-up. This will be used as the surgical guide and the impression tray.

3. EXTRACTION OF REMAINING TEETH AND PLACEMENT OF IMPLANTS (1130): The remaining lower teeth are extracted, and the bone height is reduced from the alveolar crest to the level of the root tips of the incisors. The implants are placed using the surgical guide to insure ideal implant trajectory relative to tooth position.
3 WEEKS (1140): Healing time of three weeks is recommended before the impressions should be taken. This allows time for the gingival tissues to heal to their final level.

4. IMPLANT IMPRESSION (1 150): Similar to operation 1050 described above, for implant impression edentulous mandible, impressions are made of the mandible using the Hybridge impression technique. Titanium posts are again used to create a jig connected by dual cured resin as illustrated in FIG. 18. By connecting the posts 2040, the accuracy of the impression is much better than a conventional open tray impression. The clear surgical guide is then filled with impression material, (medium body viscosity), and seated over the splinted jig. A bite registration is taken between the surgical guide and the opposing teeth. This impression therefore records three aspects in one impression, as noted previously. This technique is provides advantages to the Hybridge protocol. Subsequently, similar to the operation 1060 described above, the LABORATORY PHASE 1160 produces a metal/wax try-in as illustrated in FIG. 29.

5. METAL/WAX TRY-IN (1170): Allows verification of the metal/wax try in intra-orally. The fit of the framework on the implants is verified, carefully checking the passivity of the framework. Once the framework fit is verified, the occlusion (bite) is verified to be accurate as well. Lastly the appearance, and tooth position are checked, and the patient has an opportunity to accept the final set-up. If any of the verifications don't check out, new records are taken: check bite to record the occlusal discrepancy, and a solder index to record a passive fitting bar. Unless there are large discrepancies, the final Hybridge can be processed and finished. As above, after successful try in, the Hybridge is processed with the final acrylic (1180). The Hybridge is fastened back onto the master cast, and the occlusion is checked for a final time and adjusted as necessary

6 DELIVERY/INSERTION (1190): The Hybridge is screwed onto the implants, the occlusion is checked and adjusted as necessary. The screw access holes are filled with a light light-cured resin.

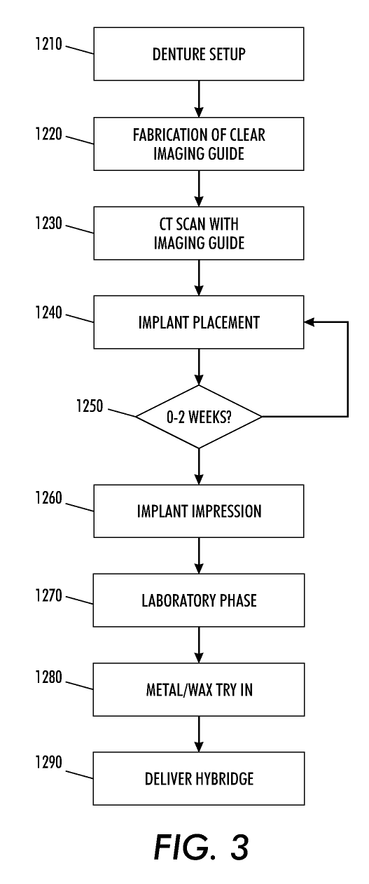

Referring next to FIG. 3, depicted therein are similar operations for MAXILLARY EDENTULOUS. Specifically, the treatment sequence is generally indicated as follows:

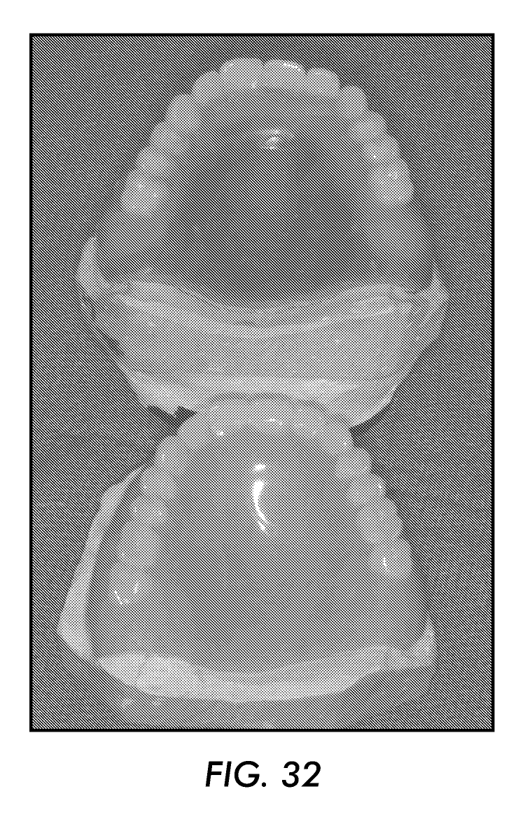

1. DENTURE SET UP, DENTURE SET UP APPOINTMENTS (1210): consists of the usual series of appointments required to fabricate an upper complete denture.
a. Primary impression.
b. Secondary impression.
c. Bite registration, face bow record, shade and mold selection, examples of which are depicted in FIG. 32.
d. Anterior try in.
e. Full try in.

2. FABRICATION OF CLEAR IMAGING GUIDE (1220): a duplication of the setup of the upper set up is processed into a clear duplicate denture by flasking the set-up. Subsequently metal markers are imbedded into the clear guide in the ideal positions for the screw holes.

3. CT SCAN WITH IMAGING GUIDE (1230): The patient wears the imaging guide during the CT scan. Implant planning is completed using a software package, ImplantMaster™, a software interface for dentists and dental laboratories for the accurate planning and placement of dental implants through the processing of medical image data. The ImplantMaster system is indicated for use as a front-end software interface for the transfer of imaging information from a medical scanner such as a CT scanner. It is also indicated for use as a planning and simulation software for use by qualified dental professionals to aid them in the placement of dental implants and surgical treatment (I-DENT IMAGING LTD.) to virtually determine implant positioning relative to the tooth position from the set-up.

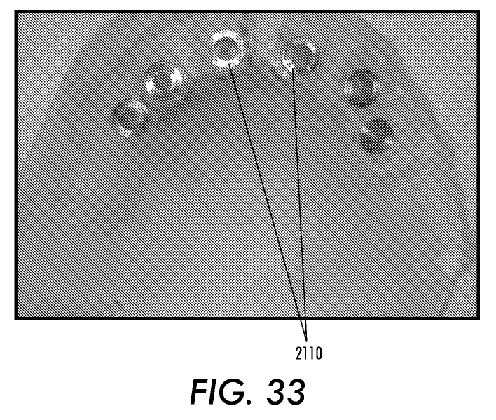

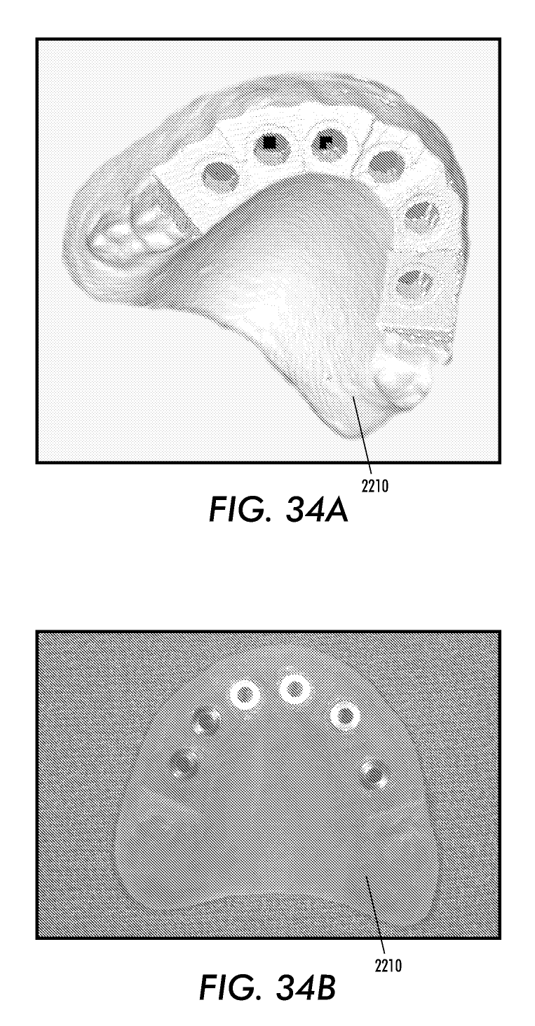

4. IMPLANT PLACEMENT (1240): The CT derived surgical guide 2210 as illustrated in FIGS. 33 and 34A-B is used to position up to six implants in an ideal location. Oftentimes an incision is not necessary, so implants can be placed through soft tissue punches.
0-2 WEEKS (1250): In most cases the impression can be done immediately after the implant placement.

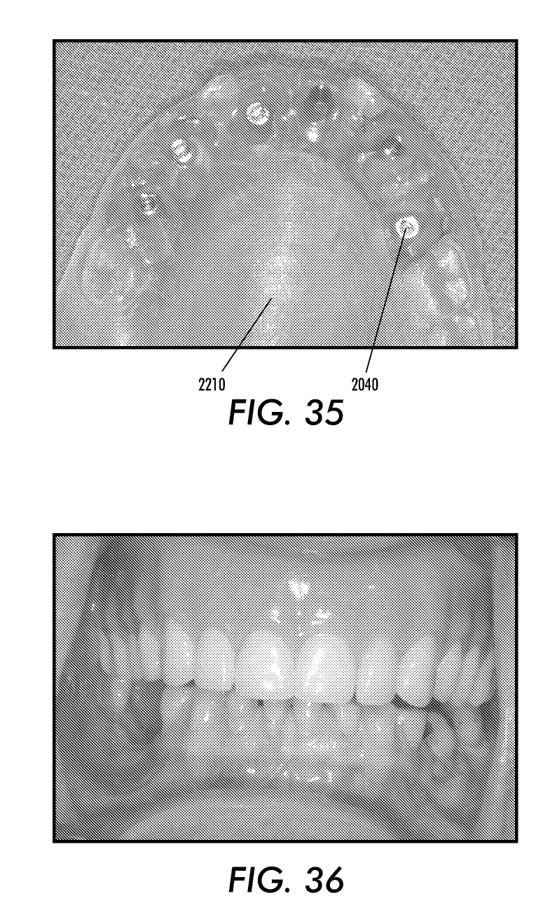

5. IMPLANT IMPRESSION (1260): As illustrated in FIG. 35, for example, titanium posts 2040 are used to create a jig from the surgical guide and the posts are connected by dual-cured resin to the guide. By connecting the tubes, the accuracy of the impression is much better than a conventional open tray impression. The clear surgical guide is relieved sufficiently about each of the posts so it can be filled with impression material, (medium body viscosity), and seated over the splinted jig. A bite registration is taken between the surgical guide and the opposing teeth. This impression therefore records three aspects in one impression: (i) implant impression, (ii) bite registration and (iii) vertical dimension.

6. LABORATORY PHASE (1270): After implant analogs are screwed on to the titanium tubes in the impression, the impression is poured in stone, creating a master cast 2320 as shown in FIG. 23A. The master cast is then mounted against the opposing lower cast as illustrated, for example, in FIG. 23C. The use of wax set-up indexed onto the healing caps is helpful to verify the mounting of the cast. Preferably six healing caps are screwed onto the analogs of the master cast. Once placed the set-up is cut back and seated on to the master cast. The bite registration is than used to mount the cast with the opposing cast. An index is than then made of the clear surgical guide/impression tray or wax set-up, using a putty impression material. By indexing the guide or preferably the set-up, the tooth positions from the denture set-up are transferred to the master cast. Once the dental technician knows the tooth position relative to the implants (analogs), the titanium framework is fabricated. Titanium posts are again fastened to the implant analogs, flat sides are positioned to approximate each other and to provide surfaces for the attachment of titanium bar stock that is sized to fit between the flat surfaces of the titanium posts. The posts and bar stock are laser welded or otherwise permanently attached to one another. The bar is completely fabricated, including the posterior cantilevers which may extend to the first molar area. The matrix is referenced to make sure the titanium framework is positioned under the desired location of the denture teeth. Once the titanium framework is completed, the denture teeth from the enture set-up are placed in the matrix, and than waxed on to the titanium bar assembly in their proper location. This then represents the metal/wax try-in of the Hybridge.

7. METAL/WAX TRY IN (1280): This operation allows verification of the metal/wax try in intra-orally as illustrated in FIG. 30. The fit of the framework on to the six implants is verified, carefully checking the passivity of the framework. Once the framework fit is verified, the occlusion (bite) is verified to be accurate as well. Lastly the appearance, and tooth position are checked, and the patient has an opportunity to accept the final set-up. If any of the verifications do not check out, new records are taken: check bite to record the occlusal discrepancy, and a solder index to record a passive fitting bar. Unless there are large discrepancies, the final Hybridge can be processed and finished for the patient's next visit.

8. DELIVER HYBRIDGE (1290) The Hybridge is screwed onto the patient implants; the occlusion is checked and adjusted as necessary. Care is taken to check the clean-ability under the Hybridge. The screw access holes are filled with a light-cured resin.

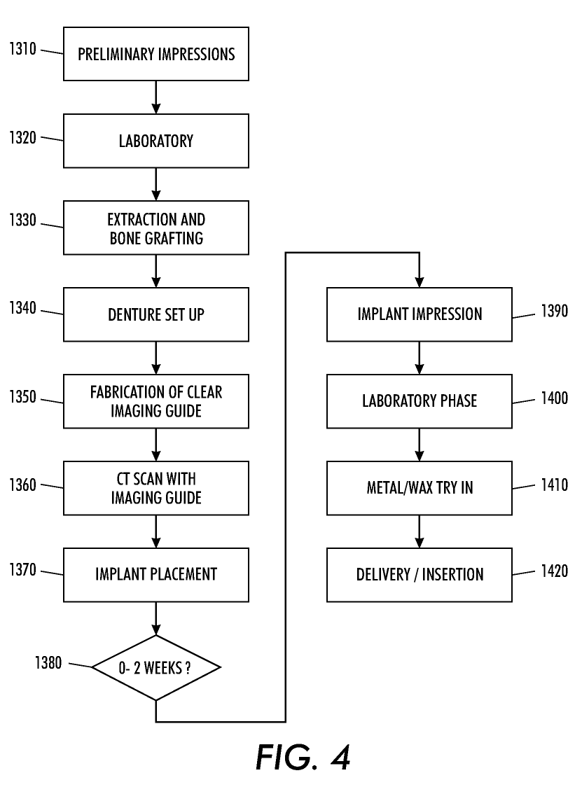

Referring now to the last flowchart, FIG. 4, depicted therein are operations for the treatment sequence for a maxillary dentate.

1. PRELIMINARY IMPRESSIONS (1310): Alginate impressions are taken of the opposing dentition and the upper teeth as illustrated in FIG. 23C. Bite registration and face bow records are preferred. Three upper impressions are taken, and one lower impression. As above, one of the upper impressions is used to fabricate the upper temporary denture; another is used to fabricate an ideal wax set-up to be used for the final Hybridge. The third impression is kept as a reference if needed in the future. Two shades are selected, one for the temporary denture, the other for the final set-up.

2. LABORATORY(1320): As illustrated, for example, in FIG. 36, an upper temporary denture is fabricated on one of the upper casts, and an ideal wax set-up is done using the second cast. Care is taken to idealize the tooth position, i.e. incisal edge position, and occlusal plane. A clear duplicate denture, is also fabricated of the ideal set-up. This will be used as the surgical guide and the impression tray.

3. EXTRACTION AND BONE GRAFTING (1330): The remaining teeth are extracted and the sockets are filled with a bone graft material. A temporary upper denture is inserted at the same appointment and lined with a tissue conditioner. All steps after the initial healing are the same as for the edentulous maxilla treatment sequence described above.

4. DENTURE SET UP DENTURE SET UP APPOINTMENTS (1340): consists of the usual series of appointments required to fabricate an upper complete denture.
a. Primary impression.
b. Secondary impression.
c. Bite registration, face bow record, shade and mold selection.
d. Anterior try in.
e. Full try in.

5. FABRICATION OF CLEAR IMAGING GUIDE (1350): a duplication of the upper set-up is processed into a clear duplicate denture by flasking the set-up. Metal markers are imbedded into the clear guide in the ideal positions for the screw holes.

6. CT SCAN WITH IMAGING GUIDE (1360): The patient wears the imaging guide during the CT scan. Implant planning is completed using a software package to virtually determine implant positioning relative to the tooth position from the set-up.

7. IMPLANT PLACEMENT (1370): The CT derived surgical guide is used to position up to six implants in an ideal location. Oftentimes an incision is not necessary, so implants can be placed through soft tissue punches.
0-2 WEEKS (1380): In most cases the impression can be done immediately after the implant placement.

8. IMPLANT IMPRESSION (1390): Titanium posts, generally in the form of cylinders, are used to create a jig connected by dual-cured resin. By connecting the posts, the accuracy of the impression is much better than a conventional open tray impression. The clear surgical guide is relieved sufficiently so it can be filled with impression material, (medium body viscosity), and seated over the splinted jig. A bite registration is taken between the surgical guide and the opposing teeth. This impression therefore records in one impression, implant impression, bite registration and vertical dimension.

9. LABORATORY PHASE (1400): After implant analogs are screwed on to the titanium tubes in the impression, the impression is poured in stone, creating a master cast. The cast is then mounted against the opposing lower cast. The use of the wax set-up indexed onto the healing caps is helpful to verify the mounting of the cast. Healing caps are screwed onto the analogs of the master cast. Once placed the set-up is cut back and seated onto the master cast. The bite registration is than used to mount the cast with the opposing cast. An index is then made of the clear surgical guide/impression tray or wax set-up, using a putty impression material. By indexing the guide, or preferably the set-up, the tooth positions from the denture set-up are transferred to the master cast. Once the dental technician knows the tooth position relative to the implants (analogs), the titanium framework is fabricated. The titanium posts are fastened to the implant analogs, flat sides of the posts are positioned to approximate each other. Titanium bar stock is then sized to fit between the flat surfaces of the titanium cylinders, and laser welded to the cylinders. The bar is completely fabricated, including the posterior cantilevers extending to the first molar area. The matrix is referenced to make sure the titanium framework is positioned under the desired location of the denture teeth. Once the titanium framework is completed, the denture teeth from the denture set up are placed in the matrix, and than waxed on to titanium bar in their proper location. This then represents the metal/wax try-in of the Hybridge.

10. METAL/WAX TRY IN (1410): Allows verification of the metal/wax try in intra-orally. The fit of the framework on to the implants is verified, carefully checking the passivity of the framework. Once the framework fit is verified, the occlusion (bite) is verified to be accurate as well. Lastly, the appearance, and tooth position are checked, and the patient has an opportunity to accept the final set-up. If any of the verifications do not check out, new records are taken: check bite to record the occlusal discrepancy, and a solder index to record a passive fitting bar. Unless there are large discrepancies, the final Hybridge can be processed and finished for the patient's next visit.

11. DELIVER HYBRIDGE (1420) The Hybridge is screwed onto the 6 six implants; the occlusion is checked and adjusted as necessary. Care is taken to check the cleans ability under the Hybridge. The screw access holes are filled with a light cured resin.

Having described the general treatment sequences, set forth below are further details of the disclosed system and methods directed to the immediate loading of a fixed hybrid prosthesis (e.g., mandibular prosthesis), that are believed to provide cost and time advantages over systems and methods previously employed. While the following description if particularly relative to a mandibular prosthesis, it will be appreciated that the prosthesis and the various techniques disclosed herein may be equally applicable to maxillary prostheses as well in accordance with the various sequences depicted in FIGS. 1-4.

The professional, in evaluating a patient as a candidate for the hybrid bridge, would make an evaluation of various factors. Considerations for a mandibular fixed hybrid bridge or similar prosthesis include: inter-arch space; bone quantity (height/width); soft tissue quality; teeth in space; surgical positioning; and hygiene accessibility.

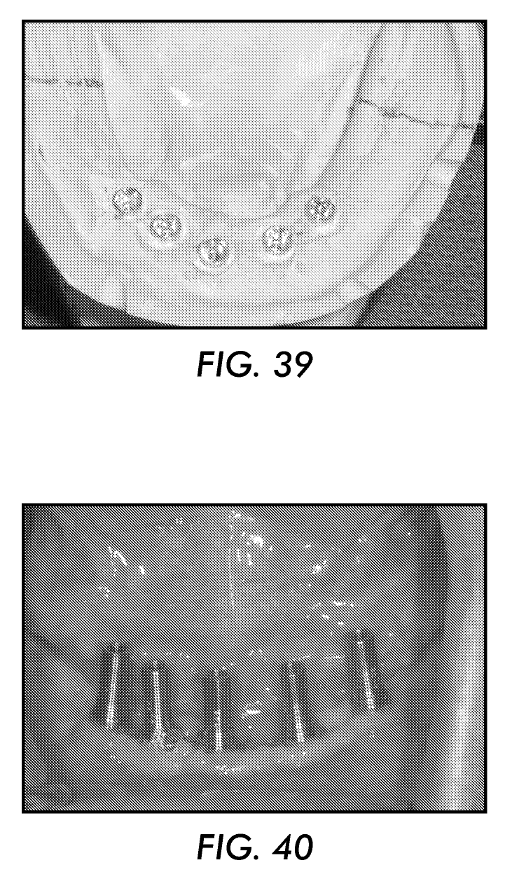

The edentulous mandible treatment sequence, depicted in the figures beginning at FIG. 39, includes: full denture set-up; fabrication of a surgical guide or stent; implant surgery; implant level impression; metal try-in; final metal/wax try-in; process and finish; and delivery. The surgical guide may be derived using computer tomography (CT). The use of a CT derived surgical guide (FIG. 34A, 34B) is preferable when working on the maxilla because the positioning of the implants is more critical as a result of the angled trajectory of the bone in the upper jaw. Often it is possible to do an incision-less (flapless) procedure with the CT guide if the bone contours are sufficient that there is not a need for bone grafting. Use of the CT guide in the mandible is typically limited because the majority of time the contours of the bone need to be modified prior to implant placement, and there is insufficient gingival thickness on the mandible to allow for a soft tissue punch for a flap less procedure. The angulations of the implants in the mandible are not as critical due to a better bone trajectory. The process includes composing a model of the patient's mouth, including a desired arrangement of a mandibular fixed hybrid prosthesis. This step is generally characterized as a full denture setup, wherein a model is constructed for the patient's dentures.

The next step is the single-stage implant surgery where a plurality of implants are inserted into the patient's jaw bone (mandible (lower) or maxilla (upper)). The type of implant to be used may include devices manufactured by Zimmer (e.g., Advent). Notably, Zimmer's implants are not the only ones that can be used, although they are contemplated by the disclosed embodiments. Alternatives include Astrotech, BioHorizons, etc. The manner of installing such implants may be in accordance with manufacturer-recommended practices, for example as found in the “Tapered Screw-Vent® and AdVent® Restorative Manual by Zimmer Dental (©2006, Zimmer Dental, Inc. Carlsbad, Calif.; Rev. 10/06), which is hereby incorporated by reference in its entirety.

Once the implant surgery is completed, an implant level impression(s) is taken. The technique employed for obtaining the impression(s) may be open or closed tray impressions, although in most situations the open tray technique is believed preferable due to improved accuracy. As described in more detail below, the open tray impressions use a resin connection to titanium posts resulting in a very accurate verification jig to be picked up in the impression. As will also be described, the use of the open tray technique may employ improved coping or post designs that facilitate accurate positioning of the array of posts. It will be appreciated that various post arrangements and associated techniques may be employed, as well as alternatives.

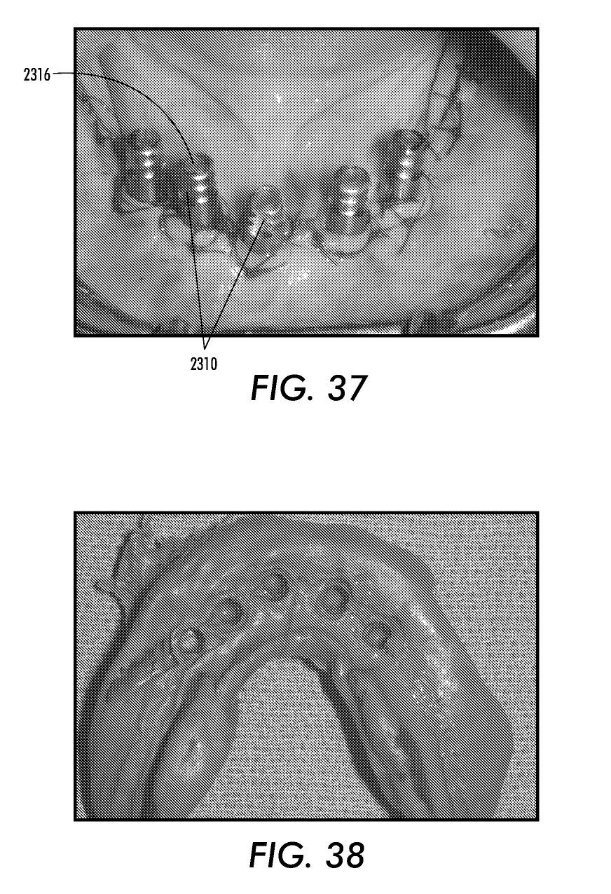

The steps for the closed tray process include (starting with FIG. 37): (i) placing an indirect transfer member 2310 (e.g., AVIT/4) in each of the implants, filling the top of the indirect transfer member with a wax 2316 or similar material to prevent the socket therein from becoming filled with impression material. (ii) placing a flexible, thin membrane (e.g., a rubber dam) over the indirect transfer members and the patient's gum area; (iii) overlaying the surgical guide filled with impression material; (iv) removing the impression material once set to reveal the position of the indirect transfer members and the patient's gum structure as seen in FIG. 38; and (v) making a master cast (FIG. 39).

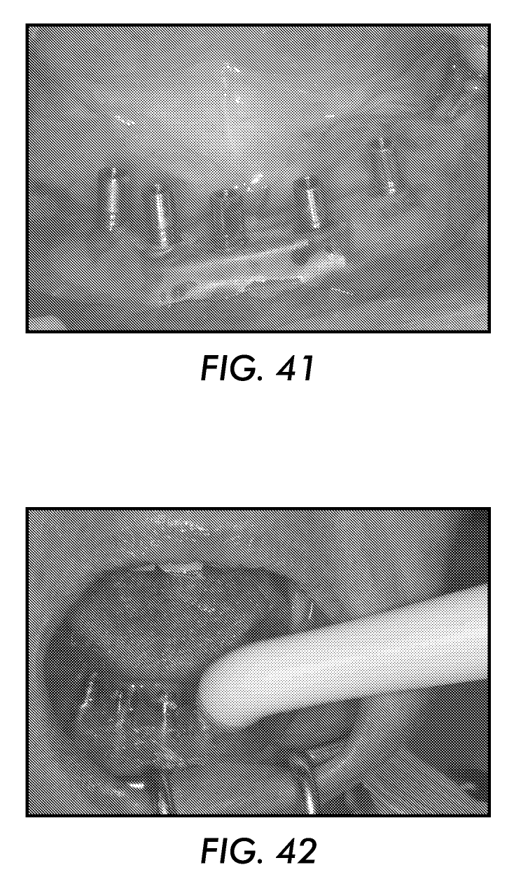

The steps for the preferred open tray impression process (beginning at FIG. 40), include: (i) placing a temporary coping (AVTT)/post, or similar tube-like component (see FIG. 40), on each of the implants (securing with a screw (AVGCS), and filling the top/socket of the coping with a wax or similar material to prevent the socket from becoming filled with impression material. Alternatively, a longer screw may be used during the impression phase to eliminate the need to wax fill or to remove/wipe excess impression material away. The screw itself may be of varying lengths or may be easily cut to an appropriate length (e.g., part of Zimmer HLPT); (ii) next the process continues with placing a flexible membrane (rubber dam) over the posts and the patient's gum area, thereby covering the gum area but leaving the posts exposed as illustrated in FIG. 41; (iii) interconnecting the plurality of posts using a UV-curable material that surrounds each coping and interconnects adjacent posts (e.g., Core Paste XP Syringe (Enamel with Fluoride, Dual-Cure)) and curing the interconnecting material as it is being applied and after using a directed ultra-violet (UV) light source as seen in FIG. 42. It is important that the step be completed using enough material to assure that the posts remain accurately affixed to one another and to thereby reflect the relationship between the posts while affixed to the implants. Optionally, once cured, some of the cured material may be removed. Next, overlaying the surgical guide and checking for clearance around the posts. Once satisfactory clearance exists, filling the area with impression material and applying the surgical guide to form a bond between the surgical guide and the impression material (note: guide may be pre-coated with a solution to promote adhesion to the impression material) and thereby encapsulating the interconnected copings and cured plastic. Excess impression material may be removed. The bite of the patient is then checked to assure proper alignment (centric occlusion, phonetics and aesthetics are evaluated). Subsequently, the tops of the posts are re-exposed (impression material removed).

A variation of this technique exists which uses the wax set-up completed of the patient. The set-up is lined with an impression material over the healing caps of the implants, so that the setup can be easily indexed onto the master cast as a further verification of the tooth position and bite relationship. Such a variation, employing the interim fitting enables improved registration of the hybrid prostheses upon final formation and installation.

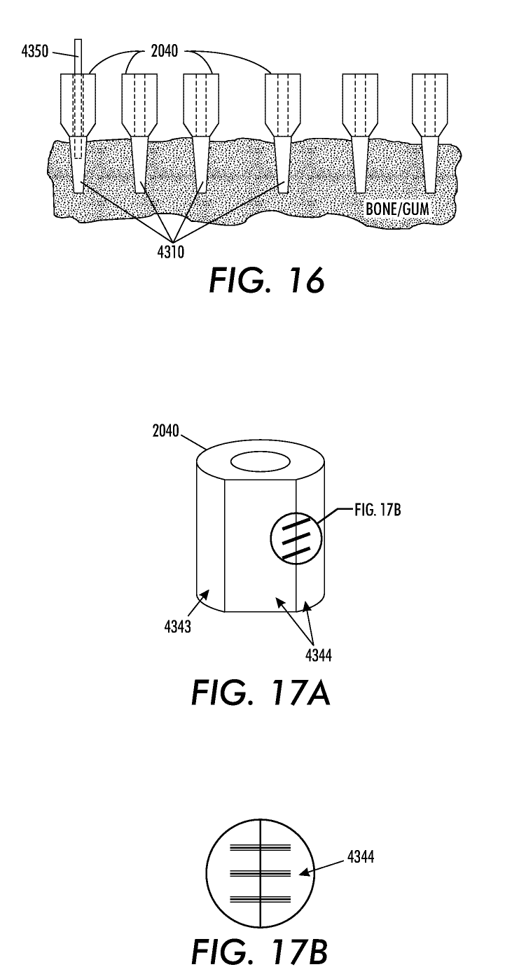

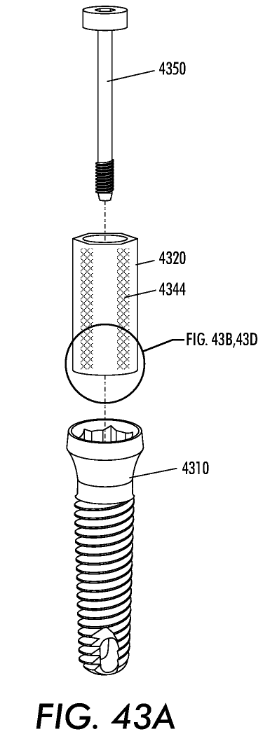

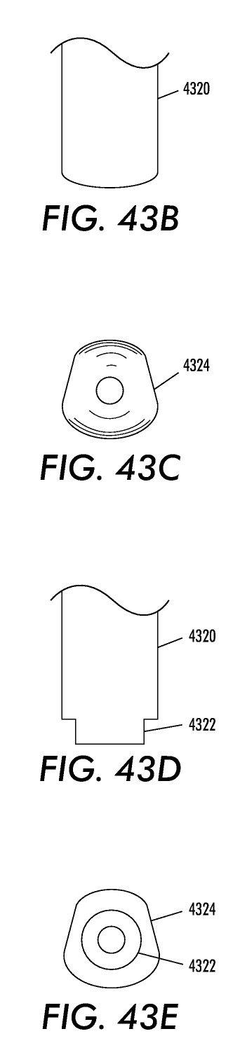

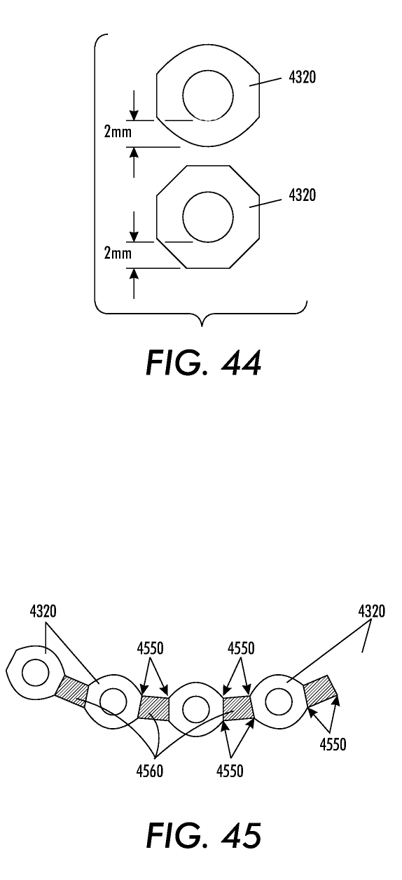

Although described and depicted as temporary posts (AVTT) the present disclosure preferably contemplates the use of a thicker-walled post or sleeve as depicted for example in FIGS. 43A-46E. As illustrated in FIG. 43A, the post 4320 is attached to the implant 4310 using a screw 4350. The post design is such that the wall thickness of the post is at least about 1.5 mm-3.0 mm and more preferably about 2 mm-2.5 mm in thickness (measured along the diameter), so that the wall is of sufficient thickness to prevent fracture of the titanium sleeve due to stress or fatigue and to permit laser welding or similar metallurgical bonding techniques to be used to permanently bond the posts in the final prosthesis. As illustrated in FIGS. 43B-C, the lower or bottom end of the post 4320 is generally convex in shape to mate with a generally concave surface found on the top of the implant. An alternative such as depicted in FIGS. 43D-E is that the bottom of the post 4320 includes a feature, such as a shoulder 4322, etc. to mate with a similar feature in the top of the implant, but preferably the post may be rotated at any orientation relative to the implant. The wall thickness of two alternative post cross-sections is depicted in FIG. 44. Moreover, the outer surface would have at least two flat surfaces that may be parallel with one another or that may be slightly angled, potentially in numerous angles, to approximate the curved arch of the anterior mandible or maxilla (front portion). As depicted in FIG. 16, the height of the posts 2040 is typically on the order of about 6 mm, but may be of alternative sizes and heights. The bottom of each post is preferably tapered to match up to the diameter of the implant top. It is also contemplated that two surfaces to which the metallic structural components are attached may be keyed or may otherwise provide for a mating surface relationship with the other components to be laser welded thereto as illustrated in more detail in FIG. 45. For example, various sized pieces of titanium bars or similar components may be available so as to reduce the time/effort required to fabricate the metallic structure as will be further described and depicted below.

As further depicted in FIG. 16, the posts include flat surfaces facing adjacent posts, where the flat surfaces are polished and suitable for laser welding material thereto. Moreover, other surfaces may be machined, etc. to provide surface structure or at least a roughened finish to assure proper adhesion of plastic materials in the impression steps (e.g., FIGS. 43, 46, 47). In one embodiment (FIG. 16), posts having a hex-like outer surface the outward-facing and inward-facing hex edges have cuts or grooves in the edges which would serve to receive plastic material and assure accurate positioning of the posts. As illustrated by FIGS. 43A-E, contemplated herein is an embodiment where the implant and improved post are components of a kit including an insert 4310, a post 4320 having at least two flat surfaces 4324 on an outer periphery thereof, and a screw 4350 for removably attaching the post to the insert, wherein the post is employed both to produce implant level impressions as well as a structure to support the prosthesis. As further depicted in FIGS. 43-47, the posts may have a number of shapes, sizes and cross-sections.

As described briefly above, each post may also have a taper at the bottom to meet up with the outer diameter of the top of the associated implant (typ. 3.5 mm or 4.5 mm diameter)—tapering up to approx. 5.5-6 mm diameter for the coping diameter. It will be further appreciated that while disclosed relative to the Hybridge embodiments, the improved post may also be employed for the creation and installation of other implants and associated devices and apparatus. By providing a greater wall thickness, and flat surfaces, the use of the improved post is believed to permit easier fabrication and improved strength of the underlying metallic structure about which the prosthesis is constructed.

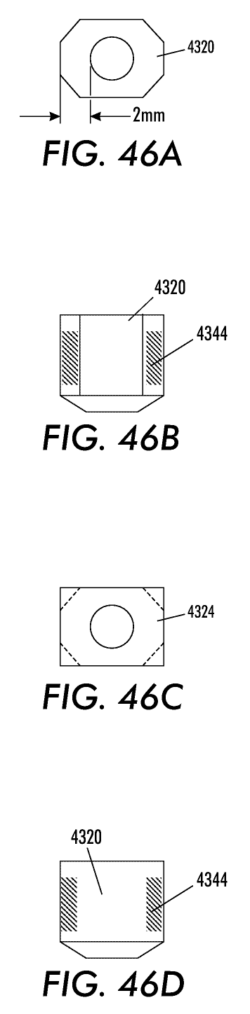

Referring also to FIGS. 46A-D, depicted therein are further alternative cross-sections of the improved copings or posts described and depicted in FIGS. 44-45. In FIG. 45, posts 4320 are laser welded, along regions 4550, to titanium bar sections 4560, to form a completed support structure for the prosthesis. In FIG. 46A-B, top and side views respectively, an octangular cross-section post is illustrated, having at least two flat surfaces 4324, as well as roughened surfaces 4344 in addition to a convex or tapered bottom for mating with the implant. In FIG. 46C-D, top and side views respectively, a rectangular cross-section post is illustrated, having at least two flat surfaces 4324, as well as roughened surfaces 4344 in addition to a convex or tapered bottom for mating with the implant. In the various embodiments illustrated, it will be understood that the copings are preferably formed of titanium so as to be compatible with the other materials being used to build the metal structure for the Hybridge™, thereby enabling laser welding and other metallurgical bonding techniques. It is, however, possible that alternative metals or other materials may be employed for the posts and related components used to form the underlying structure of the Hybridge. Moreover, one aspect of the disclosed system and methods contemplates the use of titanium posts as depicted in FIGS. 16-17A-B and 43-48, where the post has the advantage of being used for both the implant work and is subsequently useable as the post in the prosthesis. This eliminates the need for or waste of additional components.

Another aspect of the disclosed system and methods contemplates the use of a “kit” or assembly that is sold/distributed for use, where the kit includes at least an implant, a coping and the connecting screw, and may optionally include a “driver” or similar device for implant installation.

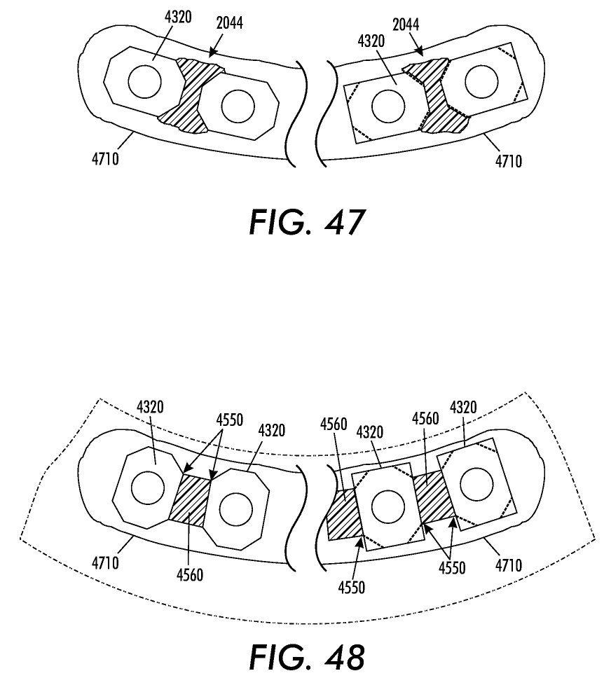

As shown in FIG. 47, the titanium posts 4320 are compatible with one or more implants and may be used in different orientations in order to assure that they both fit within the area of the open tray impression (surgical guide) yet are of adequate size and wall thickness to permit them to be used in the structure of the prosthesis (see alternative orientations in FIGS. 47 and 48. More specifically, as depicted in FIG. 46, the copings may have an oblong or elongated octagonal shape, whereas the cross-section depicted in the upper center of FIG. 47B shows a rectangular cross-section. Either shape, as well as alternatives (e.g., hexagonal, ellipse, etc.) may be suitable for use as a post cross-section.

As illustrated in FIGS. 47-48, the posts 4320 may be used in one orientation for impressions (FIG. 47) within a surgical guide opening 4710, and in an alternate orientation (e.g., rotated 90-degrees) for the base structure for the prosthetic. Such a configuration assures that the posts will fit with the space of the surgical guide, yet provide adequate wall thickness (at least approx. 2 mm) to prevent premature fracture of the coping when subject to use within a patient's mouth. As in the prior examples of FIGS. 16-17A-B, etc., the posts could include surface structure (roughness, grooves, knurling, etc. as distinguished from finished/polished surfaces 4343) at the corners or edges (4344) to retain the adhesive and/or impression material, but not interfere with the guide. It is contemplated that the approximate dimensions of a rectangular cross-section may be about 5.5 mm×3.5 mm. In summary, the alternative posts depicted in FIGS. 46A-D may also serve the dual purposes of providing one profile for impression preparation and a second profile (¼ turn) for building of the Hybridge metallic structure. An additional advantage of this embodiment is that by having titanium posts filling in most of the inter-post gaps during the impression phase (oriented end-to-end in the longitudinal direction), there is little UV-curable material that is required to fill the gap between the copings and therefore less impact on spacing of the posts from shrinkage of the UV-curable material. This may eliminate the need to cut and re-attach the copings.

In yet a further alternative embodiment, it is also possible for the post to have hex or similar implant-mating surfaces so that the post itself could be used to drive the implant into the bone instead of the separate tool used to drive implants as already done by Zimmer. For example, the coping or post may have hex on one side for driving, then flip it upside down to use it as an implant/bridge post. It will be recognized that although described as a hex-shaped surface, the mating component on the post may be of other shapes (e.g., square or octagonal), provided that a complimentary or mating shape is found in the top of the implant—assuming the post is to be used for driving the implant during insertion. In the embodiments of FIG. 43, the assembly of the post to the implant is depicted. In one embodiment, the top of the implant has a concave surface of a shoulder that is intended to mate with a corresponding surface on the bottom of the post.

Returning to the Hybridge™ process, subsequently an upper impression is made using the open tray method, wherein impression material is inserted into the maxillary area in the bite/contact region and the patient closes his/her mouth to form the contact impression with the surgical guide on the maxillary. This technique on the maxilla is now typically done with the same surgical/imaging guide as is used in the mandible. The use of the CT derived surgical guide may create some bite accuracy problems that are not experienced when using the exact duplicate of the denture set-up.

Next the screws are removed from the copings to permit the filled surgical guide to be removed from the patient's mouth to reveal the position of the copings and the patient's gum structure. To the copings, implant replicas (AVR) may then be attached and the replicas employed to produce a master cast, whereby the master cast includes embedded replicas in positions the same as that of the implants within the patient's mandible. Next, the master cast is made of the patient's mandible or maxilla and gums to permit the subsequent construction of the prosthesis thereon. In summary, the system/method of producing a master cast that incorporates implant replicas includes placing a plurality of posts (copings) into the patient's mouth and joining the posts using a UV-curable material so as to form a rigid assembly that accurately reflects the relationship of the posts relative to the implants, and then using the assembly to subsequently place the implant replicas into a master cast, thereby assuring the master cast accurately reflects the patient's mouth and implant location/orientation.

Interim Denture

In a similar manner an interim denture may be formed using a denture resembling the surgical guide, a second set of posts, whereby the posts are again interconnected using a UV-curable adhesive material, and the interim denture is placed over the interconnected posts and is permanently attached to the interconnected post assembly using a UV-curable resin (Triad® Gel, clear pink) that is applied to the copings. Once covered, the interim denture is inserted and excess UV-curable resin is removed. The patient's bite is checked and then the resin is cured to a final state by application if directed UV light. Subsequently, the screws are again removed from the copings/inserts and the interim denture is removed. The professional may then hand-modify the interim denture material to fill any gaps or regions in which the copings protrude, etc. and to essentially provide a smooth surface (both top and bottom) for the interim denture. Excess material can then be removed by hand to contour or “fine-tune” the interim denture before it is inserted into the patient's mouth.

Approximately fourteen days after implant surgery, the metal/wax try-in step is executed. In this step, a mock-up prosthesis has been prepared and is formed of the metallic base material and a wax-like outer surface. The mock-up is then inserted into the patient's mouth, in the same manner that the final prosthesis would be and the patient's centric occlusion, phonetics and aesthetics are evaluated. The passivity is also checked (i.e., the fit of the metal substructure to the implant surfaces) where the mock-up is reviewed to assure the framework sits precisely, for example, with only one screw tightened Any adjustments are noted or made to the wax mock-up so that corrections can be made in the final prosthesis.

Approximately three weeks or less after surgery, or one week or less after the try in appointment, the prosthesis has been processed and finished and is available for final installation on the patient's mandible of maxilla and may be finally adjusted for occlusion. At this time the prosthesis is also checked to assure it is hygienic, meaning that it does not present any negative impact to the patient's dental hygiene. A final polish is made and the holes where the screws are inserted are filled with a semi-permanent material to both seal the screws holding the prosthesis to the inserts as well as eliminate regions where food and other materials may collect.

In embodiments disclosed herein, the hybrid bridge (HYBRIDGE™) method utilizes on the order of five or six dental implants to anchor or secure the prosthesis in place in the patient's mouth. Although applicable to maxillary or mandibular applications, the following discussion is directed to a mandibular embodiment. The methods employed vary somewhat in accordance with the patient's current dental configuration, which may be edentulous or with a transitional denture.

As generally described above, the edentulous process begins with four primary operations: a. impression; b. bite registration; c. setup; and d. try-in into clear acrylic. For the impression step an impression is made of the patient's mandibular region. Next, bite registration is performed to assure that the relationship between the mandibular and maxillary jaws/teeth (dentures) etc. are correctly reflected in the models. In the setup step, a denture-like component is developed for the patient (based upon impressions and bite registration), and the denture-like component is duplicated into a clear acrylic component, as shown above, which may also be used as the surgical guide and imaging guide for CT scans (with some modification).

Next, the implant impressions are made. Here, the sub-steps generally include: a. place Zimmer analogs; b. add soft tissue material; c. pour in dense stone; and d. articulate. Once the original and implant impressions are complete, the prosthesis may be created using a laser-welded or cast substrate upon which the prosthetic materials are built up. In the hybrid structure, to which the present disclosure is directed, the impression tray is first removed and a plurality of sleeves, also referred to as posts, is placed on the base (with implant replicas embedded therein). The A-P ratio and spacing are then marked and reviewed, and then a plurality of bars or similar materials are welded or otherwise affixed between adjacent posts. As noted above and relative to FIG. 45, the sleeves are preferably of sufficient wall thickness to permit laser welding, and in one embodiment have a plurality of flat surfaces to make it easier to interconnect the bars and the posts. Such posts may be made from cylindrical material that has flat surfaces ground or otherwise formed on the outer periphery. To the bars and posts may be added other structure that a dental prosthetic technician may determine to be necessary to provide support for elements of the prosthesis. Moreover, the structure may include elements that extend beyond the posts so as to be cantilevered. While disclosed in the form of metal (e.g., a titanium alloy) posts and bars, the disclosed embodiments also contemplate the use of alternative materials such as polymeric compounds as well as composite materials that may include additives wherein the alternative materials provide similar supporting structure and attachment features as the posts, bars and retention elements depicted.

Next, the modeled and molded teeth are attached to the substructure using the least amount of “wax” in case it needs to be sectioned, and the molded wax assembly is then applied to the models to show the relative relation of the prosthesis to the opposed teeth (or other prosthesis). The full wax-up version is then created. Once the wax-up assembly has been tried and accepted, the prosthesis is then checked for contact on all teeth (shim stock employed), and subsequently created in an acrylic or similar material that is approved for use as a dental prosthetic. Although various techniques may be employed for production of the prosthetic assembly, one acceptable method is an injection and curing of acrylic material. The resulting prosthetic is then adjusted and finished to keep the acrylic as close as possible to the patient's gum tissue.

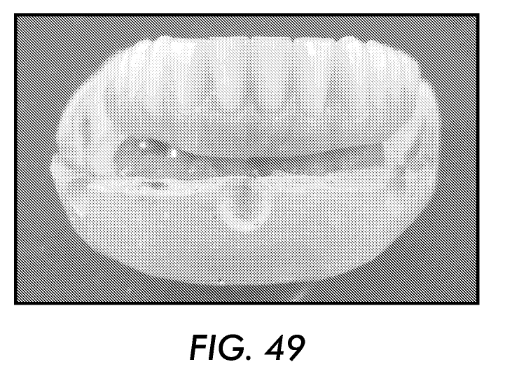

Turning next to a discussion of exemplary sub-steps in the hybrid bridge process that may be employed for a transitional denture. The steps include first selecting, setting and finishing the transitional denture on a first model (see e.g., FIG. 49), where the heights of any ridges or major undercuts may be reduced. Next, the teeth are set on a second model, where the teeth used are those to be employed in the hybrid. Then, the try-in is duplicated into clear acrylic, and the resulting acrylic used as a surgical guide and/or an impression tray as discussed above. Once completed, the procedure can continue as described above, where the implants are inserted and the implant impression is taken.

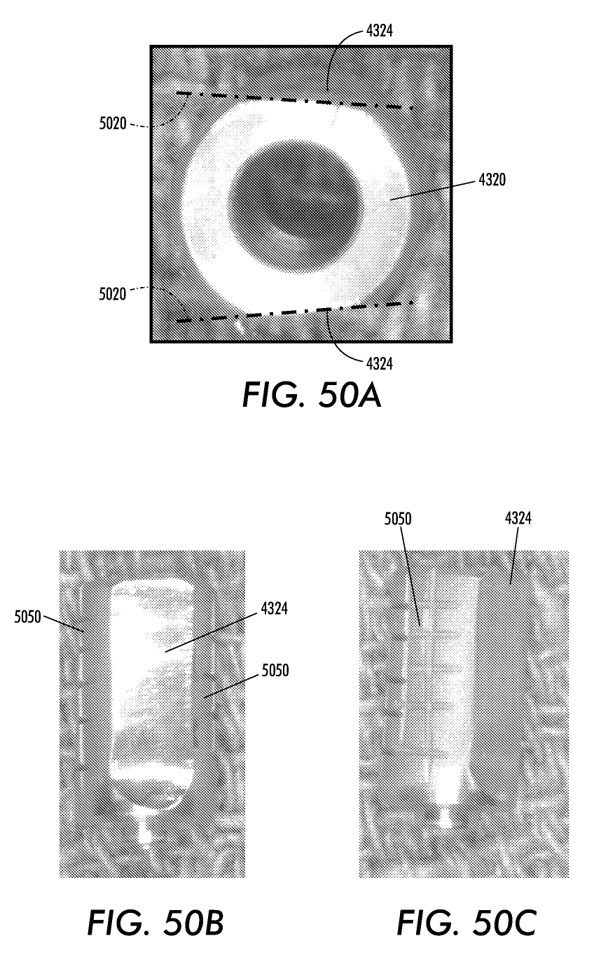

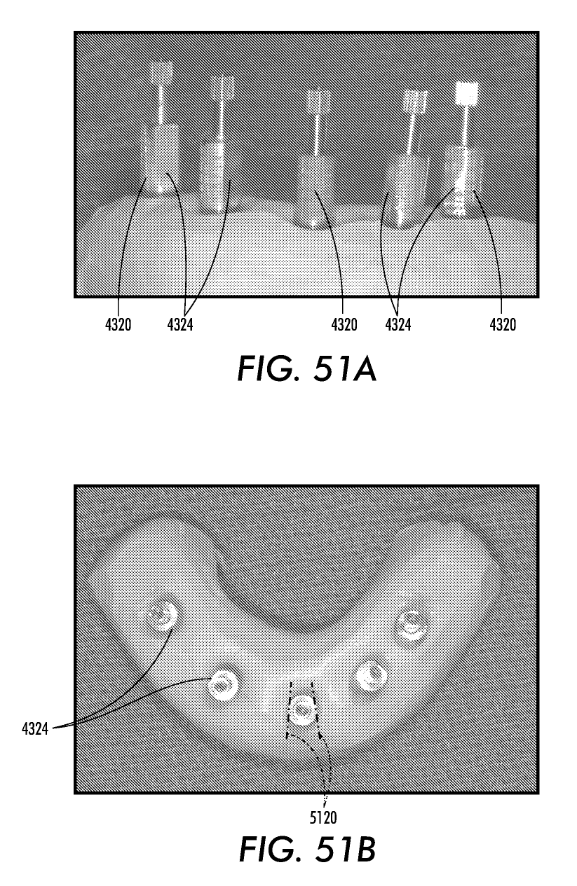

Lastly, referring to FIGS. 50A-C and 51A-B, depicted therein are illustrations of exemplary posts for use in accordance with the treatment sequences and procedures described above. Like FIGS. 16-18 and 43A-48, these illustrations depict new designs for a Hybridge™ titanium post 4320. As illustrated, opposing (proximal) sides 4324 have flattened surfaces for creating a laser welded joint to connect adjacent posts. In one embodiment, the flat sides 4320 may be slightly convergent as illustrated by lines 5020 (also see lines 5120 in FIG. 51B) to accommodate the curvature of the upper or lower jaws. Furthermore, the buccal and lingual surfaces 5050, as also depicted in FIG. 51A, are textured (e.g., crossing grooves) and/or sand-blasted, for improved adhesion of the curable resin material to the post when fabricating the impression jig described above. As depicted, the flat proximal surfaces 4324 are provided facing mesial and distal for orientation of a laser welded bar (not shown) therebetween.

It will be appreciated that various of the above-disclosed embodiments and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. A method for early loading of a fixed dental hybrid prosthesis, comprising:
developing a denture set-up for a patient;
fabricating a surgical guide;
performing single-stage implant surgery to insert a plurality of implants into the patient's mandible or maxilla;
taking an implant level impression immediately following implant surgery, wherein at least one impression utilizes the surgical guide and a plurality of implant posts including flat surfaces thereon;
producing a master cast that incorporates implant replicas therein;
producing a final metal/wax try-in;
processing and finishing a fixed hybrid prosthesis; and
installing the maxillary and or mandibular fixed hybrid prosthesis.

2. The method according to claim 1, further comprising preparing an interim hybrid prostheses.

3. The method according to claim 1, wherein the same implant posts are employed in the fixed hybrid prosthesis as well.

4. The method according to claim 1, wherein producing a master cast that incorporates implant replicas includes placing a plurality of posts into the patient's mouth and joining the posts using a curable material to form an assembly that accurately reflects the relationship of the posts relative to the implants, and using the assembly to subsequently place the implant replicas into a master cast, thereby assuring the master cast reflects the patient's mouth as well as the implant location and orientation.

5. The method according to claim 4, wherein the posts are elongated in cross-section, and are used first orientation for the implant level impressions and second within the fixed hybrid prosthesis.

6. The method according to claim 1, wherein said fixed hybrid prosthesis is installed within three weeks of performing implant surgery.

7. The method according to claim 1, wherein said implant post comprises:
an elongated cross-section; and
an outer surface including at least one generally planar surface, and a region on said outer surface having a surface roughness to enable the temporary bonding of an adhesive thereto,
said implant post being suitable for use in the implant level impression as well as the fixed hybrid prosthesis.

8. A method for the immediate loading of a fixed, hybrid dental prosthesis, comprising:
performing single-stage implant surgery to insert a plurality of implants into a patient's jaw bone;
taking an implant level impressions immediately following implant surgery, wherein at least one impression utilizes a surgical guide and a plurality of implant posts including flat surfaces thereon;
producing a master cast that incorporates implant replicas therein;
producing a metal try-in;
producing a final metal/wax try-in;
processing and finishing a fixed hybrid dental prosthesis within about three weeks of performing implant surgery; and
installing the fixed hybrid dental prosthesis.

9. The method according to claim 8, wherein the same implant posts are employed in the processing and finishing of the fixed hybrid prosthesis.

10. The method according to claim 8, wherein producing a master cast that incorporates implant replicas includes placing a plurality of implant posts into the patient's mouth and joining the implant posts using a curable material to form an assembly that accurately reflects the relationship of the posts relative to the implants, and using the assembly to subsequently place the implant replicas into a master cast, thereby assuring the master cast reflects the patient's mouth as well as the implant location and orientation.

11. The method according to claim 10, wherein the implant posts are elongated in cross-section, and are used for the implant level impressions and within the fixed hybrid prosthesis.

12. The method according to claim 8, wherein at least one of the implant posts comprises:
an elongated cross-section; and
an outer surface including at least one generally planar surface, and a region on said outer surface having a roughened surface to enable the temporary bonding of an adhesive thereto,
said implant post being suitable for use in the implant level impression as well as the fixed hybrid prosthesis.

13. A system for the immediate loading of a fixed, hybrid dental prosthesis, comprising an implant kit used for each of a plurality of implants used to anchor the prosthesis, said kit including an insert, a post having at least two flat surfaces on an outer periphery thereof, and a screw for removably attaching the post to the insert, wherein the post is employed to first produce implant level impressions and second to provide a structure to support the prosthesis.

14. The system of claim 13, wherein the posts are packaged with the implant.

15. An implant post suitable for use in a dental prosthesis, comprising:
an elongated cross-section; and
an outer surface including at least one generally planar surface, and a region on said outer surface having a roughened surface to enable the temporary bonding of a polymeric adhesive thereto,
said implant post being suitable for use in an implant level impression as well as a fixed hybrid prosthesis.

16. The implant post according to claim 15, wherein an end of said post is generally convex in shape to mate with a generally concave surface of an implant.

17. The implant post according to claim 15, wherein an end of said post includes a shoulder to mate with a surface of an implant.

18. The implant post according to claim 16, wherein said post includes a through-hole for receiving a screw to affix the post to the implant and where an opposite end of said post includes a recess to receive a head of the screw therein.

19. The implant post according to claim 17, wherein said post includes a through-hole for receiving a screw to affix the post to the implant and where an opposite end of said post includes a recess to receive a head of the screw therein.

20. A system for the immediate or early loading of a fixed dental hybrid prosthesis, comprising:
a denture set-up developed for the patient;
a surgical guide fabricated based upon the denture setup;
a plurality of implants inserted into the patient's jaw;
an implant level impression taken immediately following implant surgery, wherein at least one impression utilizes the surgical guide and a plurality of implant posts including at least one flat surface thereon;
a master cast that incorporating the implant posts therein;
a final metal/wax try-in; and
a fixed hybrid prosthesis installed on the patient's jaw.
